(19) United States
(12) Patent Application Publication
(10) Pub. No.: US 2015/0378374 A1
(43) Pub. Date: Dec. 31, 2015

(54) PROGRAMMABLE SUPPLY DOMAIN PULLDOWN

(71) Applicant: TEXAS INSTRUMENTS DEUTSCHLAND GMBH, Freising (DE)

(72) Inventors: Matthias ARNOLD, Freising (DE); Johann ZIPPERER, Unterschleissheim (DE); Frank DORNSEIFER, Freising (DE)

(73) Assignee: TEXAS INSTRUMENTS DEUTSCHLAND GMBH, Freising (DE)

(21) Appl. No.: 14/317,118

(22) Filed: Jun. 27, 2014

(51) Int. Cl. G05F 1/46

(52) U.S. Cl. CPC G05F 1/46

(57) ABSTRACT

A power gated electronic device that includes a power supply domain coupled to a power gate switch, a comparator, and control logic. The power supply domain is configured to receive voltage from a power supply. The comparator is configured to receive voltage from the power supply domain and compare the voltage from the power supply domain with a threshold level. The control logic is configured to receive the output of the comparator and, based on the comparison between the voltage from the power supply domain and the threshold level, cause the power supply domain to pulldown.

### CROSS-REFERENCE TO RELATED APPLICATION

None.

### BACKGROUND

As mobile electronic devices and systems increase in number, techniques for reducing energy consumption become increasingly important. Mobile electronic systems are typically powered by batteries or other energy sources of limited capacity. Complex power management schemes may be employed in an attempt to reduce the energy consumption of the electronic device and extend the operational life of the energy source. A parameter for modern low power digital designs, in particular for microcontroller based applications like portable or mobile electronic devices, is the current consumption in a low power mode. In today's low power digital designs, power gating of electronic domains (i.e. circuits) is an approach to reduce power consumption while keeping the system operable. According to the power gating approach, a digital circuit is disconnected from the power supply once it is not needed.

Power to core circuitry in today's low power digital designs is typically provided by a power source, such as a voltage regulator which provides power to a power supply domain. The power supply domain translates the voltage received from the power supply to a voltage that a core circuitry requires. According to the power gating approach, when the core circuitry does not need power, the power supply domain is cut off from the power supply. Once the power supply domain loses its voltage, whether through leakage or by being pulled down, the core circuitry also loses its power. Thus, less power is consumed. However, letting the power supply domain float can cause non-reproducible wake up behavior due to lingering parasitic capacitance.

### SUMMARY

The problems noted above are solved in large part by systems and methods for programmable supply domain pulldown of power supply domains. In some embodiments, a power gated electronic device includes a power supply domain coupled to a power gate switch, a comparator, and control logic. The power supply domain is configured to receive voltage from a power supply. The comparator is configured to receive voltage from the power supply domain and compare the voltage from the power supply domain with a threshold level. The control logic is configured to receive the output of the comparator and, based on the comparison between the power supply domain and the threshold level, cause the power supply domain to pulldown.

Another illustrative embodiment includes a method that comprises receiving, by a comparator, a voltage from a power supply domain. The method also comprises comparing, by the comparator, the voltage from the power supply domain with a threshold level. Additionally, the method includes receiving, by control logic, the result of the comparison. The method also comprises, based on the comparison between the voltage from the power supply domain and the threshold level, initiating voltage pulldown of the power supply domain.

Yet another illustrative embodiment is a system including a power supply, a power supply domain coupled to a power gate switch, a delay circuit coupled to the power supply domain, and control logic. The power supply domain is configured to receive voltage from the power supply. The delay circuit is configured to receive voltage from the power supply domain and delay in time the voltage from the power supply domain. The control logic is configured to receive the output of the delay circuit and cause the power supply domain voltage to pulldown.

### BRIEF DESCRIPTION OF THE DRAWINGS

For a detailed description of exemplary embodiments of the invention, reference will now be made to the accompanying drawings in which:

FIG. 1 shows a block diagram of an illustrative programmable power gated electronic device in accordance with various embodiments;

FIG. 2 shows a block diagram of an illustrative programmable power gated electronic device in accordance with various embodiments;

FIG. 3 shows a block diagram of an illustrative programmable power gated electronic device in accordance with various embodiments;

FIG. 4 shows example voltage levels in a power supply domain in accordance with various embodiments; and

FIG. 5 shows a flow diagram of a programmable power domain pulldown method in accordance with various embodiments;

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection, or through an indirect connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The demand for low power solutions in mobile electronic devices is increasing. Power gating of electronic domains is one approach to reduce power consumption while keeping the system operable. Power gating causes a digital circuit to disconnect from the power supply once it is not needed, thus reducing power consumption. This is possible by utilizing a power gate that may open, thus disconnecting a power supply from a power supply domain. Core circuitry which is connected to the power supply domain is thus, also disconnected from the power source. Once the power supply domain is disconnected from the power source, the voltage stored in the power supply domain may either be allowed to float or pulled down. Allowing the power supply domain to float may cause non-reproducible behavior upon subsequently waking up the core circuitry due to capacitance from a capacitor utilized to stabilize supply voltages and/or a persistent parasitic capacitance. However, while pulling down the power supply domain is safe and defined, energy is wasted on the parasitic capacitors. Thus, there is a need for a programmable power gated device which allows the configuration of if and/or when the power supply domain is pulled down to be programmable.

By utilizing a programmable comparator (level trigger) alone or in combination with a programmable time delay circuit and control logic, or just a programmable time delay circuit, a user can configure how the power supply domain will react when a power gate is opened disconnecting the power supply domain from the power supply. The programmable comparator allows for a pulldown of the voltage in the power supply domain to occur as the power supply domain's voltage reaches a programmable threshold level. The programmable time delay circuit allows for a pulldown of the voltage in the power supply domain to occur after a programmable delay time. A combination of the comparator and the time delay circuit allows for a pulldown of the voltage of the power supply domain to occur after the power supply domain's voltage reaches a programmable threshold level and a programmable delay time.

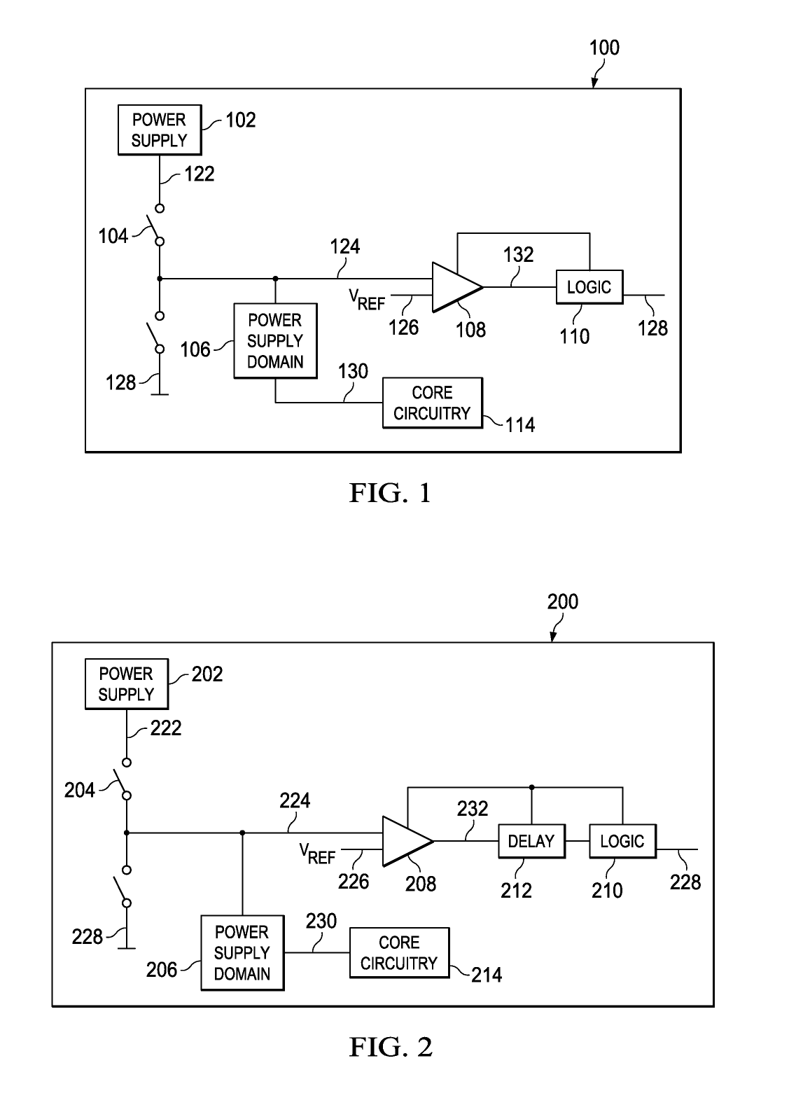

FIG. 1 shows a block diagram of an illustrative power gated electronic device 100 in accordance with various embodiments. In an embodiment, electronic device 100 is a microcontroller. The electronic device 100 includes power supply 102, power gate 104, power supply domain 106, comparator 108, control logic 110, and core circuitry 114. Power supply 102 provides voltage 122 to power supply domain 106. In an embodiment, power supply 102 is a voltage regulator which is designed to automatically maintain a constant voltage level. Power supply 102 may supply voltage 122 to power supply domain 106.

Power gate 104 is a switch that may disconnect power supply 102 from the remaining components of electronic device 100 when power gate 104 is open. Thus, when power gate 104 is open, power supply domain 106 will not receive voltage 122 from power supply 102. However, when power gate 104 is closed, power supply domain 106 receives voltage 122 from power supply 102.

Power supply domain 106 is a power domain that provides power to core circuitry 114 of electronic device 100, and is thus coupled to core circuitry 114. In an embodiment, power supply domain 106 translates voltage 122 received from power supply 102 down to 1.5 volts, shown as voltage 130. Voltage 130 is then provided to core circuitry 114. Thus, core circuitry 114 may receive a lower voltage than produced by power supply 102.

Core circuitry 114 is a domain within electronic device 100 which provides core functionality to electronic device 100, such as processing capabilities. Core circuitry 114 receives voltage 130 from power supply domain 106. In one example, core circuitry 114 includes a central processing unit.

Once power gate 104 is opened, power supply domain 106 does not receive voltage 122 from power supply 102. At that point, the voltage held by power supply domain 106 begins to naturally leak. Additionally, the voltage 124 stored by power supply domain 106 is then received by comparator 108. In some embodiments, comparator 108 is a simple comparator built with logic gates that does not actively consume current and compares its input with a transistor threshold voltage. In alternative embodiments, comparator 108 is configured to receive reference voltage 126 as well as voltage 124. Reference voltage 126 may be generated by a reference voltage regulator.

Comparator 108 compares voltage 124 with a threshold level and outputs signal 132 with the result of the comparison. Threshold level may be programmable, and as such may be altered based on a user's preference. Thus, comparator 108 may compare voltage 124 with reference voltage 126. In an embodiment, reference voltage 126 is the threshold level of a transistor. The result of the comparison is signal 132 which may be asserted either high or low depending on the comparison.

Control logic 110 receives the result of the comparison as signal 132. If the signal 132 indicates that the result of the comparison shows that voltage 124 is less than comparator 108's threshold level, then control logic 110 causes a pulldown signal 128 to be sent to power supply domain 106. The pulldown signal causes any of the remaining voltage stored in power supply domain 106 to pulldown (i.e. it causes a loss of charge in the power supply domain 106 due to a short circuit). In addition to the power supply domain 106 losing voltage, a pulldown of power supply domain 106 also causes core circuitry 114 to lose power, and thus, power consumption in electronic device 100 is reduced.

However, if the signal 132 indicates that the result of the comparison shows that voltage 124 is greater than or equal to comparator 108's threshold level, then control logic 110 then pulldown signal 128 is asserted as high. In this scenario, power supply domain 106 will continue to leak voltage and comparator 108 will continue to receive voltage 124 from power supply domain 106 and compare it to the threshold level. This cycle will continue until either control logic 110 receives signal 132 indicating that the result of the comparison shows that voltage 124 is less than comparator 108's threshold level, thereby causing a pulldown signal to be sent to power supply domain 106 or power gate 104 is closed resulting in power supply domain 106 again receiving voltage 122 from power supply 102. Because the pulldown signal 128 is sent based on the voltage in the power supply domain 106 falling below a threshold level, the comparator 108 combined with the control logic 110 may be termed a level trigger.

FIG. 2 shows a block diagram of an illustrative power gated electronic device 200 in accordance with various embodiments. Electronic device 200 is similar to electronic device 100 from FIG. 1, except electronic device 200 has an additional delay circuit 212. Electronic device 200 may be a microcontroller. The electronic device 200 includes power supply 202, power gate 204, power supply domain 206, comparator 208, control logic 210, time delay circuit 212 and core circuitry 214. Power supply 202 provides voltage 222 to power supply domain 206. In an embodiment, power supply 202 is a voltage regulator which is designed to automatically maintain a constant voltage level. Power supply 202 may supply voltage 222 to power supply domain 206.

Power gate 204 is a switch that may disconnect power supply 202 from the remaining components of electronic device 200 when power gate 204 is open. Thus, when power gate 204 is open, power supply domain 206 will not receive voltage 222 from power supply 202. However, when power gate 204 is closed, power supply domain 206 receives voltage 222 from power supply 202.

Power supply domain 206 is a power domain that provides power to core circuitry 214 of electronic device 200, and is thus coupled to core circuitry 214. In an embodiment, power supply domain 206 translates voltage 222 received from power supply 202 down to 1.5 volts, shown as voltage 230. Voltage 230 is then provided to core circuitry 214. Thus, core circuitry 214 may receive a lower voltage than produced by power supply 202.

Core circuitry 214 is a domain within electronic device 200 which provides core functionality to electronic device 200, such as processing capabilities. Core circuitry 214 receives voltage 230 from power supply domain 206. In one example, core circuitry 214, includes a central processing unit.

Once power gate 204 is opened, power supply domain 206 does not receive voltage 222 from power supply 202. At that point, the voltage held by power supply domain 206 begins to naturally leak. Additionally, the voltage 224 stored by power supply domain 206 is then received by comparator 108. In some embodiments, comparator 208 is a simple comparator built with logic gates that does not actively consume current and compares its input with a transistor threshold voltage. In alternative embodiments, comparator 108 is configured to receive reference voltage 226 as well as voltage 224. Reference voltage 226 may be generated by a reference voltage regulator.

Comparator 208 compares voltage 224 with a threshold level and outputs signal 232 with the result of the comparison. The threshold level may be programmable, and as such, may be altered based on a user's preference. Thus, comparator 208 may compare voltage 224 with reference voltage 226. In an embodiment, reference voltage 226 is the threshold level of a transistor. The result of the comparison is signal 232 which may be asserted either high or low depending on the comparison.

Delay circuit 212 receives the result of the comparison as signal 232. Delay circuit 212 may be any type of time delay circuit which delays in time signal 232 from reaching control logic 210. Delay circuit 212 may be programmable, and thus, the amount of time that the circuit delays signal 232 from reaching control logic 210 may be adjustable and set to meet the user's requirements.

Control logic 210 receives the result of the comparison as signal 232, delayed in time by delay circuit 212. If the signal 232 indicates that the result of the comparison shows that voltage 224 is less than comparator 208's threshold level, then control logic 210 causes a pulldown signal 228 to be sent to power supply domain 206 which then pulls down and the voltage in power supply domain 206 drops to zero. In addition to the power supply domain 206 losing voltage, core circuitry 214 also loses power once power supply domain 206 pulls down, and thus, power consumption in electronic device 200 is reduced.

However, if the signal 232 indicates that the result of the comparison shows that voltage 224 is greater than or equal to comparator 208's threshold level, then control logic 210 does not output pulldown signal 228. In this scenario, power supply domain 206 will continue to leak voltage and comparator 208 will continue to receive voltage 224 from power supply domain 206 and compare it to the threshold level. This cycle will continue until either control logic 210 receives signal 232 indicating that the result of the comparison shows that voltage 224 is less than comparator 208's threshold level, thereby causing a pulldown signal to be sent to power supply domain 206 or power gate 204 is closed resulting in power supply domain 206 again receiving voltage 222 from power supply 202. Because the result of the comparison signal 232 is delayed by delay circuit 210, if power gate 204 closes during the delay period after the voltage 124 drops below the threshold level, power supply domain 206 will not pulldown.

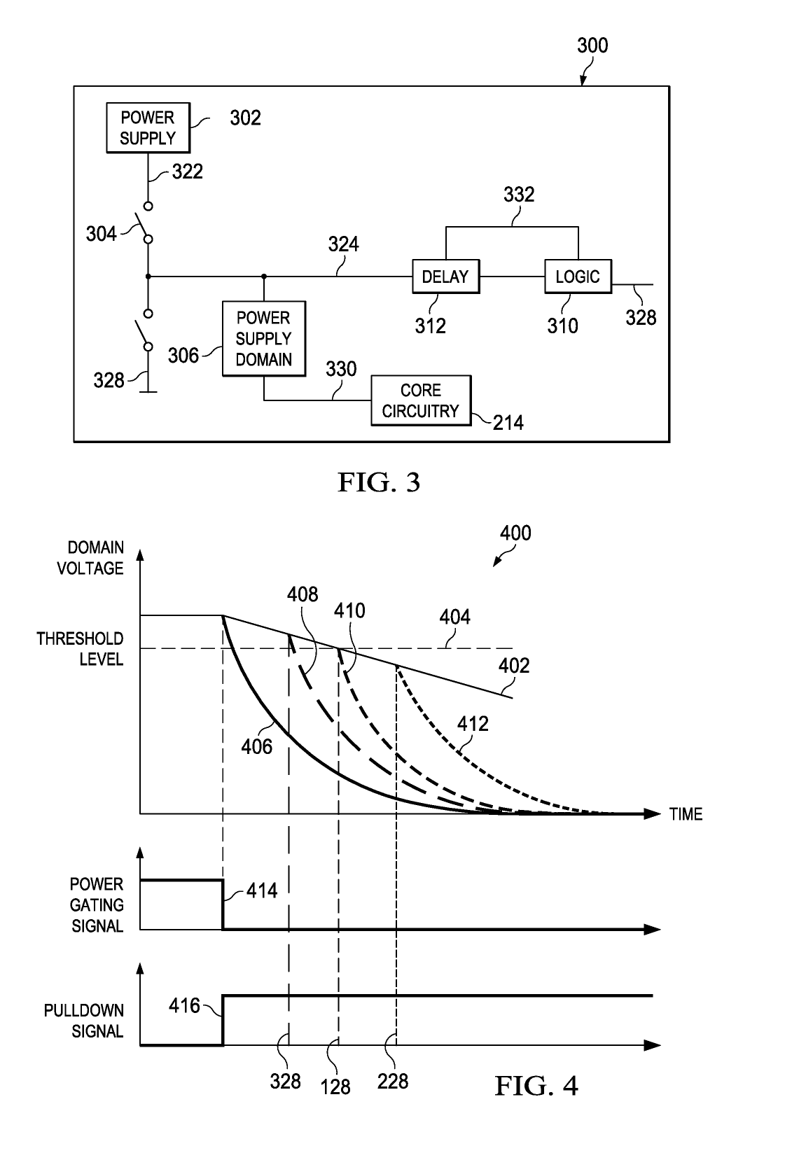

FIG. 3 shows a block diagram of an illustrative power gated electronic device 300 in accordance with various embodiments. Electronic device 300 is similar to electronic device 200 from FIG. 2, except electronic device 300 does not contain a comparator such as comparator 208. Electronic device 300 may be a microcontroller. The electronic device 300 includes power supply 302, power gate 304, power supply domain 306, control logic 310, time delay circuit 312 and core circuitry 314. Power supply 302 provides voltage 322 to power supply domain 306. In an embodiment, power supply 302 is a voltage regulator which is designed to automatically maintain a constant voltage level. Power supply 302 may supply voltage 322 to power supply domain 306.

Power gate 304 is a switch that may disconnect power supply 302 from the remaining components of electronic device 300 when power gate 304 is open. Thus, when power gate 304 is open, power supply domain 306 will not receive voltage 322 from power supply 302. However, when power gate 304 is closed, power supply domain 306 receives voltage 322 from power supply 302.

Power supply domain 306 is a power domain that provides power to core circuitry 314 of electronic device 300, and is thus coupled to core circuitry 314. In an embodiment, power supply domain 306 translates voltage 322 received from power supply 302 down to 1.5 volts, shown as voltage 330. Voltage 330 is then provided to core circuitry 314. Thus, core circuitry 314 may receive a lower voltage than produced by power supply 302.

Core circuitry 314 is a domain within electronic device 300 which provides core functionality to electronic device 300, such as processing capabilities. Core circuitry 314 receives voltage 330 from power supply domain 306. In one example, core circuitry 314, includes a central processing unit.

Once power gate 304 is opened, power supply domain 306 does not receive voltage 322 from power supply 302. At that point, the voltage held by power supply domain 306 begins to naturally leak. Additionally, the voltage 324 stored by power supply domain 306 is then received by delay circuit 312. Delay circuit 312 may be any type of time delay circuit which delays in the voltage 324 from reaching control logic 310. Delay circuit 312 may be programmable, and thus, the amount of time that the circuit delays voltage 324 from reaching control logic 310 may be set to meet a user's requirements. More specifically, control logic 310 may trigger delay circuit 312's delay through control signal 332.

Control logic 310 receives voltage 324, delayed in time by delay circuit 312. Once control logic 310 receives voltage 324, control logic 310 causes pulldown signal 328 to be sent to power supply domain 306 which then pulls down and the voltage in power supply domain 306 drops to zero. In addition power supply domain 306 losing voltage, core circuitry 314 also loses power once power supply domain 306 pulls down, and thus, power consumption in electronic device 300 is reduced.

In this scenario, power supply domain 306 will continue to leak voltage until either control logic 310 receives voltage 324, thereby causing a pulldown signal to be sent to power supply domain 206 or power gate 304 is closed resulting in power supply domain 306 again receiving voltage 322 from power supply 302. Because the voltage 324 is delayed by delay circuit 310, if power gate 304 closes during the delay period, power supply domain 306 will not pulldown.

FIG. 4 shows example voltage levels 400 in a power supply domain, such as power supply domains 106, 206, and 306, in accordance with various embodiments. Voltage curve 402 represents the voltage in a power supply domain where a power gate is signaled to open at time 414 and a pulldown signal is never received by the power supply domain. In this scenario, the power supply domain begins to naturally leak to a lower level, but does not drop dramatically.

Voltage curve 406 represents the voltage in a power supply domain where a power gate is signaled to open at time 414 and a pulldown signal 416 is immediately received by the power supply domain at the time the power gate is opened. In this scenario, as shown in voltage curve 406, voltage immediately drops when the power gate opens.

Voltage curve 408 represents the voltage in a power supply domain where a power gate is signaled to open at time 414, but a pulldown signal is delayed by a delay circuit. Thus, voltage curve 408 is representative of the voltage characteristics of power supply domain 306 from FIG. 3 once power gate 304 is opened. The pulldown signal 328 is delayed due to delay circuit 312, and thus voltage in power supply domain 306 naturally leaks through the programmed delay time and then drops once pulldown signal 328 is received by power supply domain 306.

Voltage curve 410 represents the voltage in a power supply domain where a power gate is signaled to open at time 414, but a level trigger causes the pulldown. Thus, voltage curve 410 is representative of the voltage characteristics of power supply domain 106 from FIG. 1 once power gate 104 is opened. The voltage in power supply domain 106 naturally leaks until the voltage in power supply domain 106 reaches the threshold level 404. Once the voltage in power supply domain 106 reaches the threshold level 404, pulldown signal 128 causes the voltage in power supply domain 106 to drop.

Voltage curve 412 represents the voltage in a power supply domain where a power gate is signaled to open at time 414, but a level trigger in combination with a delay circuit causes the pulldown. Thus, voltage curve 412 is representative of the voltage characteristics of power supply domain 206 from FIG. 2 once power gate 204 is opened. The voltage in power supply domain 206 naturally leaks until the voltage in power supply domain 106 reaches the threshold level 404 and an additional time delay caused by delay circuit 212. Once the voltage in power supply domain 206 reaches the threshold level 404 and the programmed delay time has passed, pulldown signal 228 causes the voltage in power supply domain 206 to drop.

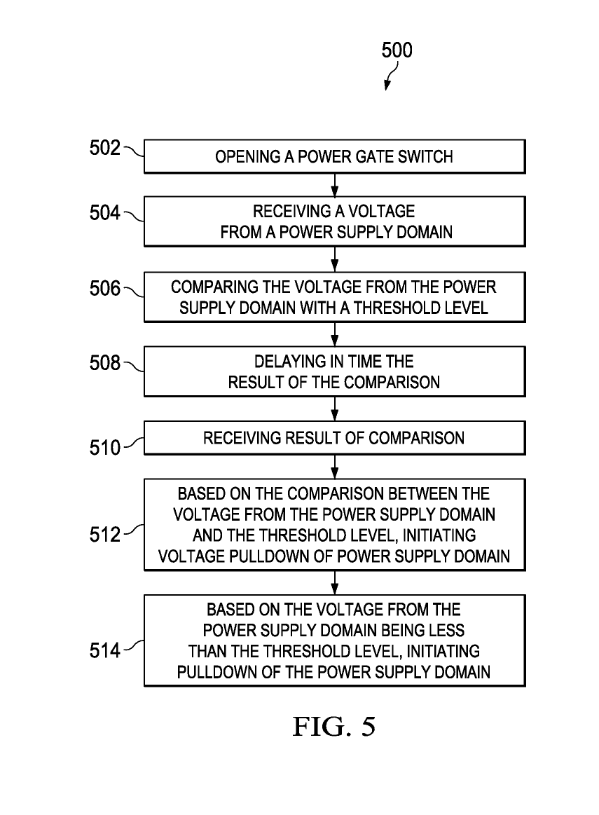

FIG. 5 shows a flow diagram of a programmable power domain pulldown method 500, in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 500, as well as other operations described herein, can be performed by control logic 110, 210, and 310 and implemented by a processor executing instructions stored in a non-transitory computer readable storage medium.

The method 500 begins in block 502 with the opening of power gate switch 204. The power gate switch 204 may be coupled to a power supply domain 206 and a power supply 202. In block 504, method 500 continues with receiving a voltage 224, by a comparator 208, a voltage 224 from power supply domain 206. In block 506, method 500 continues with comparing, by the comparator 208, the voltage 224 from power supply domain 206 with a threshold level. The threshold level may be programmable and, in some embodiments, is a reference voltage 226. In block 508, the method 500 continues with delaying in time, by a delay circuit 212, the result of the comparison 232 from reaching control logic 210. The delay time may be programmable and may, in some embodiments, be zero. In other words, in some embodiments, no delay or delay circuit is required.

In block 510, the method 500 continues with receiving, by the control logic 210, the result of the comparison. In block 512, the method 500 continues with, based on the comparison between the voltage 224 from the power supply domain 206 and the threshold level, initiating voltage pulldown of power supply domain 206. In block 514, the method 500 continues with, based on the voltage 224 from the power supply domain 206 being less than the threshold level, initiating pulldown of the power supply domain 206.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A power gated electronic device, comprising:
a power supply domain coupled to a power gate switch, the power supply domain configured to receive voltage from a power supply;
a comparator configured to receive voltage from the power supply domain and compare the voltage from the power supply domain with a threshold level; and
control logic configured to receive the output of the comparator and, based on the comparison between the voltage from power supply domain and the threshold level, cause the power supply domain voltage to pulldown.

2. The power gated electronic device of claim 1, further comprising a delay circuit coupled to the comparator and the control logic, the delay circuit configured to delay in time the output of the comparator from reaching the control logic.

3. The power gated electronic device of claim 1, wherein the comparator is a comparator without active current consumption.

4. The power gated electronic device of claim 1, wherein the comparator is further configured to receive as input a reference voltage as the threshold level.

5. The power gated electronic device of claim 1, wherein the power supply domain is coupled to a core circuitry of the electronic device.

6. The power gated electronic device of claim 1, wherein the control logic is configured to cause the power supply domain voltage to pulldown based on the voltage from the power supply domain being less than the threshold level.

7. The power gated electronic device of claim 1, wherein the control logic causes the power supply domain voltage to pulldown based on the power gate switch being open.

8. The power gated electronic device of claim 1, wherein the power supply is a voltage regulator.

9. A method, comprising:
receiving, by a comparator, a voltage from a power supply domain;
comparing, by the comparator, the voltage from the power supply domain with a threshold level;
receiving, by control logic, result of the comparison; and
based on the comparison between the voltage from the power supply domain and the threshold level, initiating voltage pulldown of the power supply domain.

10. The method of claim 9, further comprising delaying in time, by a delay circuit, the result of the comparison from reaching the control logic.

11. The method of claim 10, wherein the time of delay is programmable in the delay circuit.

12. The method of claim 9, wherein the threshold level is programmable.

13. The method of claim 9, further comprising opening a power gate switch, the power gate switch coupled to the power supply domain and a power source.

14. The method of claim 9, further comprising, based on the voltage from the power supply domain being less than the threshold level, initiating voltage pulldown of the power supply domain.

15. A system comprising:
a power supply;
a power supply domain coupled to a power gate switch, the power supply domain configured to receive voltage from the power supply;
a delay circuit coupled to the power supply domain configured to receive voltage from the power supply domain and delay in time the voltage from the power supply domain; and
control logic configured to receive the output of the delay circuit and cause the power supply domain voltage to pulldown.

16. The system of claim 15, further comprising:
a comparator coupled to the power supply domain and the delay circuit and configured to receive voltage from the power supply domain and compare the voltage from the power supply domain with a threshold level; and
wherein the delay circuit is further configured to receive the output of the comparator.

17. The system of claim 16, wherein the control logic is further configured to initiate voltage pulldown of the power supply domain based on the voltage from the power supply domain being less than the threshold level.

18. The system of claim 17, wherein the threshold level is programmable.

19. The system of claim 15, wherein the time delay is programmable in the delay circuit.

20. The system of claim 15, wherein the control logic is further configured to initiate voltage pulldown of the power supply domain based on the power gate switch transition ing from closed to open.
